(19) United States
(12) Patent Application Publication
(10) Pub. No.: US 2006/0068179 A1
(43) Pub. Date: Mar. 30, 2006

(54) Fuse applications of reactive composite structures

(76) Inventors: Timothy P. Weihs, Baltimore, MD (US); Ellen M. Heian, Cockeysville, MD (US); Ramzi Vincent, Bowie, MD (US); Somasundaram Valliappan, Cockeysville, MD (US); Etienne Besnoin, Baltimore, MD (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/228,085

(22) Filed: Sep. 16, 2005

Related U.S. Application Data
(63) Continuation-in-part of application No. 10/247,998, filed on Sep. 20, 2002, now Pat. No. 6,991,856.
Application No. 10/247,998 is a continuation-in-part of application No. 09/846,486, filed on May 1, 2001, now Pat. No. 6,736,942.
Application No. 10/247,998 is a continuation-in-part of application No. 09/846,422, filed on May 1, 2001, now abandoned.
Application No. 10/247,998 is a continuation-in-part of application No. 09/846,447, filed on May 1, 2001, now Pat. No. 6,534,194.
(63) Continuation-in-part of application No. 10/814,243, filed on Apr. 1, 2004.
(63) Continuation-in-part of application No. 10/959,502, filed on Oct. 7, 2004.
(63) Continuation-in-part of application No. 10/976,877, filed on Nov. 1, 2004.
(63) Continuation-in-part of application No. 10/843,352, filed on May 12, 2004.
(60) Provisional application No. 60/692,857, filed on Jun. 22, 2005.
(60) Provisional application No. 60/201,292, filed on May 2, 2000.
(60) Provisional application No. 60/201,292, filed on May 2, 2000.
(60) Provisional application No. 60/201,292, filed on May 2, 2000.
(60) Provisional application No. 60/461,196, filed on Apr. 9, 2003.
(60) Provisional application No. 60/509,526, filed on Oct. 9, 2003.
(60) Provisional application No. 60/516,775, filed on Nov. 3, 2003.
(60) Provisional application No. 60/469,841, filed on May 13, 2003.
(60) Provisional application No. 60/692,822, filed on Jun. 22, 2005.

(51) Int. Cl. B32B 3/00

(52) U.S. Cl. 428/209

(57) ABSTRACT

In accordance with the invention, a fuse comprises a reactive composite structure to interrupt the flow of current in a circuit. The term fuse, as used herein, is intended to cover current interrupters generically and thus encompasses fuses, circuit breakers and other devices for interrupting the flow of current through a conductor. Reactive composite structures comprise two or more phases of materials spaced in a controlled fashion throughout a composite in uniform layers, local layers, islands, or particles. Upon appropriate excitation, the materials undergo an exothermic chemical reaction that spreads rapidly through the composite structure generating heat and light. Moreover a reactive composite structure can break apart upon reaction. This breakage can rapidly interrupt the flow of current through the reactive composite structure. Such structures can provide high-speed current interruption. In addition, reactive composite structures can have abrupt reaction initiation thresholds such that a pulse of energy of a certain magnitude may initiate a clearing reaction but a slightly smaller pulse of energy may not. Such a reactive composite structure can thus provide a high speed, highly sensitive current interrupter.

### CROSS-REFERENCE TO RELATED APPLICATIONS

This application claims the benefit of U.S. provisional Patent Application Ser. No. 60/692,857 filed by T. Weihs et al. on Jun. 22, 2005 (“Applications of Reactive Composite Structures”) which is incorporated herein by reference.

This application is a continuation-in-part of U.S. patent application Ser. No. 10/247,998 filed by T. Weihs et al. on Sep. 4, 2003, (“Methods of Making and Using Freestanding Reactive Multilayer Foils”). The '998 application, in turn, is a continuation-in-part of three U.S. patent applications: 1) U.S. application Ser. No. 09/846,486 filed by T. Weihs et al. on May 1, 2001 (“Freestanding Reactive Multilayer Foils”); 2) U.S. application Ser. No. 09/846,422 filed by T. Weihs et al. on May 1, 2001 (“Reactive Multilayer Structures for Ease of Processing and Enhanced Ductility”) and 3) U.S. application Ser. No. 09/846,447 filed by T. Weihs et al. on May 1, 2001 (“Method of Making Reactive Multilayer Foil and Resulting Product”). The above '486 application, '422 application and '447 application each claims the benefit of U.S. provisional application Ser. No. 60/201,292 filed by T. Weihs et al. on May 2, 2000 (“Reactive Multilayer Foils”). Each of the above applications ('998, '486, '422, '447 and '292) is incorporated herein by reference.

This application is also a continuation-in-part of U.S. application Ser. No. 10/814,243 filed by T. P. Weihs et al. on Apr. 1, 2004 (“Hermetically Sealed Product and Related Methods of Manufacture”) which, in turn, claims the benefit of Ser. No. 60/461,196 filed Apr. 9, 2003.

This application is further a continuation-in-part of U.S. application Ser. No. 10/959,502 filed by T. P. Weihs et al. on Oct. 7, 2004 (“Methods of Controlling Multilayer Foil Ignition”) which claims the benefit of Ser. No. 60/509,526 filed Oct. 9, 2003.

This application is also a continuation-in-part of U.S. application Ser. No. 10/976,877 filed by T. P. Weihs et al. on Nov. 1, 2004 (“Methods and Device for Controlling Pressure in Reactive Multilayer Joining and Resulting Product”) which, in turn, claims the benefit of 60/516,775 filed Nov. 4, 2003.

And this application is further a continuation-in-part of U.S. application Ser. No. 10/843,352 (“Method of Controlling Thermal Waves in Reactive Multilayer Joining and Resulting Product”) filed May 12, 2004 which claims the benefit of 60/469,841 filed May 13, 2003. Each of the aforementioned '243, '196, '502, '526, '877, '775, '352 and '841 applications are incorporated herein by reference.

This application incorporates by reference copending U.S. Ser. No. 60/692,822 filed by Yuwei Xun et al. and entitled “Methods of Making Reactive Composite Structures, Resulting Products and Applications Thereof”.

### STATEMENT REGARDING FEDERALLY SPONSORED RESEARCH

The United States Government has certain rights in this invention pursuant to Award 70NANB3H3045 supported by NIST through its Advanced Technology Program.

### FIELD OF THE INVENTION

This invention relates to reactive composite structures. In particular, it concerns methods and devices using such structures to interrupt current flow in electrical circuits.

### BACKGROUND OF THE INVENTION

Fuses are important components in a wide variety of electrical circuits. A fuse is placed in a circuit current path and, in response to an unduly high current, the fuse interrupts the flow of current. The fuse thus reduces the risk of damage to sensitive electrical components, the risk of fire due to short circuits and the risk of injury from electrical shock.

A typical fuse comprises a piece of wire, termed a “link”, held in place as by a container. Current passing through the circuit passes through the fuse. The link is designed with carefully controlled properties so that if the current exceeds a limiting value for a limiting length of time, the link wire melts and falls away from its connections, interrupting the flow of current through the circuit (“clearing” the circuit).

Unfortunately, conventional fuses have a number of limitations. One limitation is the delay time between the onset of melting and the interruption of current. Between melting and clearing, there is usually an instant when electricity arcs across the first gap formed in the link. This arcing not only delays clearing, it also can conduct enough current to damage sensitive circuits.

Another limitation is the difficulty of providing a sharp current threshold. The threshold between the service condition (when the fuse is conducting) and the clearing condition is a function of both current and time. A small excursion of current above the rated current will not result in an immediate clear. Some circuits require sensitive protection, and standard fuses are not always adequate. Accordingly there is a need for more sensitive, faster-clearing fuses.

### BRIEF SUMMARY OF THE INVENTION

In accordance with the invention, a fuse comprises a reactive composite structure to interrupt the flow of current in a circuit. The term fuse, as used herein, is intended to cover current interrupters generically and thus encompasses fuses, circuit breakers and other devices for interrupting the flow of current through a conductor. Reactive composite structures comprise two or more phases of materials spaced in a controlled fashion throughout a composite in uniform layers, local layers, islands, or particles. Upon appropriate excitation, the materials undergo an exothermic chemical reaction that spreads rapidly through the composite structure generating heat and light. Moreover a reactive composite structure can break apart upon reaction. This breakage can rapidly interrupt the flow of current through the reactive composite structure. Such structures can provide high-speed current interruption.

In addition, reactive composite structures can have abrupt reaction initiation thresholds such that a pulse of energy of a certain magnitude may initiate a clearing reaction but a slightly smaller pulse of energy may not. Such a reactive composite structure can thus provide a high speed, highly sensitive current interrupter.

### BRIEF DESCRIPTION OF THE SEVERAL VIEWS OF THE DRAWINGS

The nature, beneficial features and applications of the invention will be apparent from consideration of the features and embodiments illustrated in the accompanying drawings. In the drawings:

FIG. 1 schematically illustrates a typical reactive composite structure during reaction;

FIG. 2 shows an exemplary electrical circuit employing a fuse comprising a reactive composite structure;

FIG. 3 is a schematic illustration of a first embodiment of a fuse comprising a reactive composite structure;

FIGS. 4a and b are graphical plots of current vs. time to reaction for exemplary fuse links of reactive composite structure;

FIG. 5 illustrates a second embodiment of a fuse comprising a reactive composite structure (“RCS”);

FIG. 6 shows a third embodiment of an RCS fuse;

FIG. 7 illustrates an example of a FIG. 6 fuse;

FIG. 8 shows an alternative embodiment of an RCS fuse wherein an RCS link portion is in series with a conventional link portion;

FIG. 9 illustrates an alternative embodiment of an RCS fuse that produces a visual signal of link breakage;

FIGS. 10A and 10B depict a sample of RCS link material that produces visual signals upon reaction; and

FIG. 11 is a graph illustrating annealing effects.

It is to be understood that these drawings are for the purpose of illustrating the concepts of the invention and are not to scale.

### DETAILED DESCRIPTION OF THE PREFERRED EMBODIMENT

This description is divided into three parts. Part I describes the nature of reactive composite structures and ways of making them. Part II provides a variety of illustrative fuse applications, and Part III describes beneficial features of reactive composite structures and methods for tailoring those features for particular applications.

I. The Nature of Reactive Composite Structures and Ways of Making Them

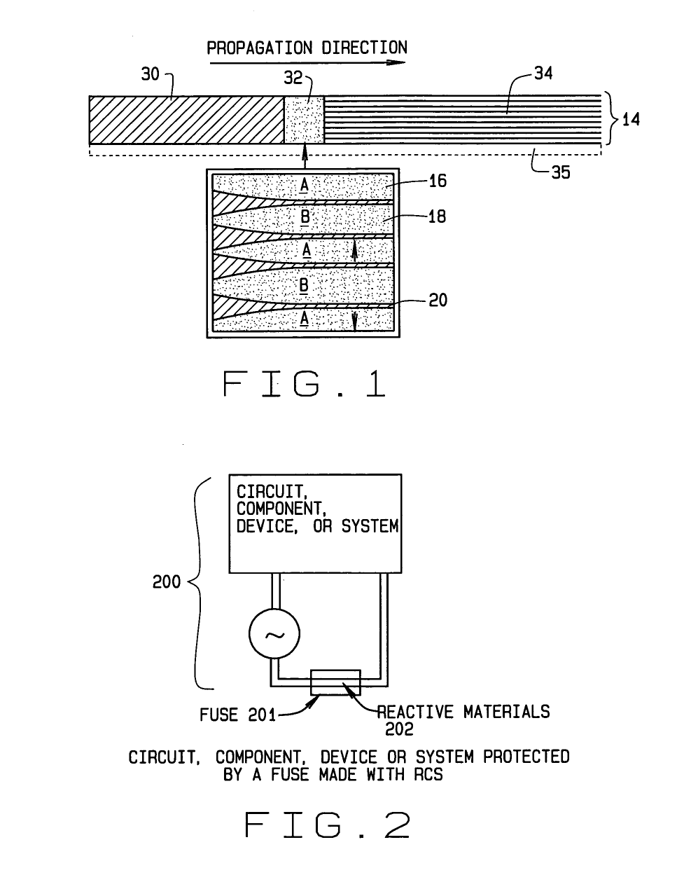

The external geometries of reactive composite structures can be in any one of a variety of forms including composite foils, composite wires, composite rods and composite bulk form bodies. Referring to the drawings, FIG. 1 illustrates a reactive composite foil 14 composed of alternating phases or layers 16 and 18 of materials A and B, respectively, that can exothermically react. These alternating layers 16 and 18 can be any materials amenable to mixing of neighboring atoms (or having changes in chemical bonding) in response to a stimulus. The materials A/B can, for example, be those that react to form silicides (Rh/Si; Ni/Si, Zr/Si), aluminides (Ni/Al, Ti/Al, Monel/Al, Zr/Al), borides (Ti/B), carbides (Ti/C); they can be thermite reacting compounds (e.g. Al/Fe₂O₃, Al/Cu₂O); they can be reduction-formation reacting compounds (e.g. Ti/B₄C, Zr/CaB₆, Hf/WC); or they can be reduction-nitridation reacting compounds (e.g. Ti/Ni₃N, Zr/BN, or Hf/WN).

The materials (A/B) used in the fabrication of the reactive foil are preferably chemically distinct. In advantageous embodiments they alternate between a transition metal (e.g. Ti, Ni) and a light element (e.g. B, Al). Preferably, the pairs (A/B) of elements are chosen to form stable reaction products with large negative heats of formation and high adiabatic reaction temperatures.

The notable property of composite structures is that upon ignition they react in a self-propagating fashion to rapidly produce intense heat and light. They can also be designed and tailored to react more slowly, producing heat and light over a longer period of time. When a composite foil 14 is exposed to a stimulus (e.g. a spark or energy pulse at one end), neighboring atoms from materials A and B mix (as shown in region 30). The change in chemical bonding caused by this mixing results in reduction of the atomic bond energy, thus generating heat in an exothermic chemical reaction. This change in chemical bonding occurs as layers with A-A bonds (i.e. layer 16) and layers with B-B bonds (layer 18) exchange to A-B bonds, thereby reducing the chemical energy stored in each layer and generating heat.

FIG. 1 further illustrates that the generated heat diffuses through foil 14 from reacted section 30 through reaction zone 32 to unreacted section 34 and initiates additional mixing of the unreacted layers. As a result, a self-sustaining, self-propagating reaction is produced through foil 14. With sufficiently large and rapid heat generation, the reaction propagates across the entire foil 14 at velocities typically greater than 0.1 m/s. As the reaction does not require additional atoms from the surrounding environment (e.g. it does not require environmental oxygen), the reaction makes foil 14 a self-contained source of energy capable of rapidly emitting bursts of heat and light, reaching temperatures above 1300K and producing a local heating rate reaching above 10⁶ K/s. This energy is particularly useful in applications requiring production of heat rapidly and locally.

Reactive composite wires and rods have analogous structures and properties. The wires and rods typically comprise concentric alternating layers or phases of reactive composite structures A/B, and upon stimulus at one end, they undergo a self-propagating reaction rapidly propagating from one end along their length to the other end. Reactive composite wires can support tension in their longitudinal dimension, rods can provide rigidity and foils can resist tension in two dimensions, as well as providing impermeable area coverage. Meshes can be formed by punching or interweaving foils or interweaving wires.

Applicants have developed a variety of methods of fabricating reactive composite structures. Reactive composite foils have been made by vapor deposition, deformation of jacketed composite assemblies and cold rolling of assembled layers or phases. Freestanding foils have been made by physical vapor deposition of alternating layers under conditions of low stress. For further details see T. P. Weihs et al., U.S. Pat. No. 6,736,942 issued May 18, 2004 (“Freestanding Reactive Multilayer Foils”) which is incorporated herein by reference. An alternative approach is to dispose a composite (layered or particulate) assembly in a metal jacket, deform and flatten the jacketed assembly and remove the jacket. For further details see T. P. Weihs et al., U.S. Pat. No. 6,534,194 issued Mar. 18, 2003, which is incorporated herein by reference. Yet a third approach is to repeatedly deform a composite assembly slowly under high pressure. See Y. Xun et al., U.S. Provisional Application Ser. No. 60/692,822 filed Jun. 22, 2005 (“Methods of Making Reactive Composite Structures, Resulting Products and Applications Thereof”).

Reactive composite wires and rods can be made by forming cylindrical assemblies of layers or phases, disposing the cylindrical assemblies in a cylindrical jacket and deforming and drawing the wires or rods.

II. Fuse Applications of Reactive Composite Structures

There are circuits, components, devices, and systems that require protection from over-current, damaging current surge, grounding, and electrical short. The protection requires interruption or disconnection of current flow. The interruption mechanism or disconnection materials must be designed to function efficiently as a part of circuits, components, devices, or systems. However such mechanisms or materials must react quickly enough to protect the circuits, components, devices, or systems, yet slow enough to ignore non-damaging transient currents.

Reactive composite structures can be used to interrupt or disconnect current flow in a variety of circuit protection devices including fast acting fuses, dual element fuses, and slow acting fuses, as well as sensors to sense over-current conditions. They can also be used to interrupt other types of flow such as radiation or magnetic energy.

The ability to tailor the ignition sensitivity of reactive composite structures can be beneficial in detecting undesired current conditions, and the ability to tailor reaction time upon ignition can be beneficial in interrupting or disconnecting a current path before damage is done to circuits, components, devices, or systems. In addition, the reaction of the reactive composite structure can cause a change in color or other optical property that can provide an indication that the circuit has been interrupted or disconnected by the reactive composite structure. Also the concentrated and/or intense heat energy from a reactive composite structure can produce a high gas pressure to separate parts of components, devices, or systems from the current path. This high heat energy could also melt or vaporize part of the current path. The inherent densification of the reactive composite structures when they react can also be used to break apart the reactive composite structure and thereby interrupt current flow. In addition, reactive composite structures can be designed and placed in various ways by forming shapes using sheets, strips, wires, and meshes, as well as particles, rods, tubes or other solid forms that can be produced using predetermined dimensions or mixed in with other materials, and bulk material forms that can be shaped.

Referring to the drawings, FIG. 2 schematically illustrates an electrical circuit 200 employing a fuse 201 comprising a link composed of a reactive composite structure (“RCS”) 202. The RCS is advantageously electrically conductive in its unreacted state and the material formed by its reaction may be nonconductive. During normal conditions, an operational current can flow through the RCS 202 as part of the circuit 200. When an undesired current spike occurs outside of desirable range of amplitude and rise time, the RCS reacts, breaking down the current path and rapidly interrupting the flow of current through the circuit 200.

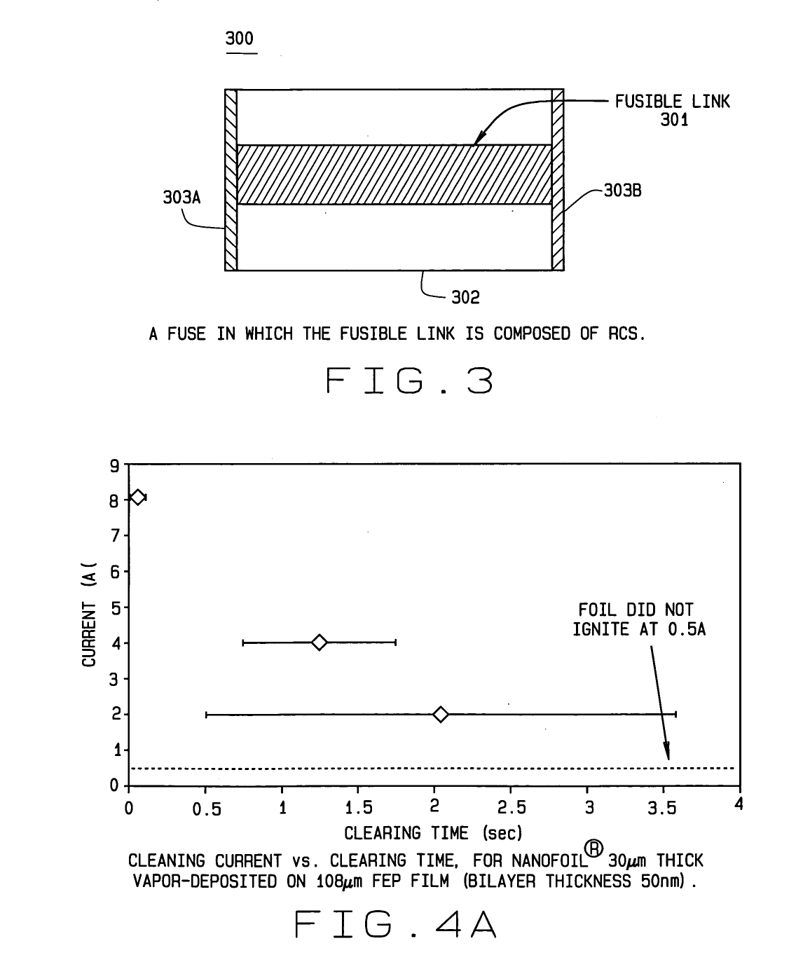

FIG. 3 is an enlarged schematic view of a fuse 300 comprising a link 301 composed of RCS disposed within an enclosure 302, e.g., glass, and extending between conductive contacts 303A and 303B. Typically the dimensions of link, enclosure and contacts are chosen to fit a standard fuse receptor connected to the circuit. The RCS link 301 can be used to carry all the current that travels across the fuse.

As an example, the RCS link can be a vapor deposited nickel-aluminum nanoscale foil (layers 20 and 30 nm thick, respectively, making a bilayer thickness of 50 nm) deposited on a fluorinated ethylene propylene (“FEP”) film. The foil and film can have thicknesses of 30 and 100 micrometers, respectively.

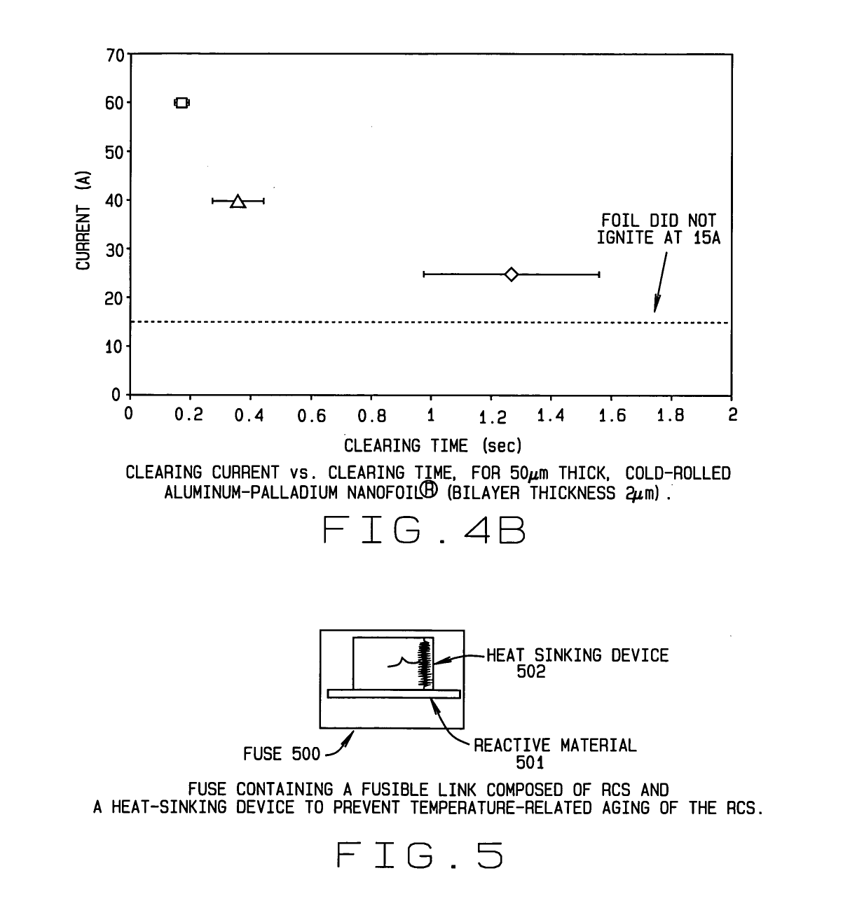

FIG. 4a is a plot of current against time to failure (reaction) for samples of this RCS cut into strips 1.5 mm wide by 12 mm long.

As a second example, the RCS link can be a mechanically-deformed aluminum-palladium multilayer foil, 50 μm thick with a bilayer thickness of 2 μm. FIG. 4b is a plot of current against time to failure (reaction) for samples of this RCS cut into strips 6 mm wide by 40 mm long.

When current flows through a length of RCS, heat is generated. The heat may cause the RCS to anneal, changing over time its reaction characteristics, including the current required to ignite the RCS and thus break the fusible link. It is thus desirable to protect the RCS link from such time and temperature related changes. Advantageously, time and temperature related changes can be reduced or eliminated by appropriate selection of the chemical system used for the RCS material. For example, use of an aluminum-zirconium foil rather than an aluminum-nickel foil leads to increased resistance to aging. This is because zirconium requires a higher temperature to diffuse into aluminum than does nickel.

FIG. 5 schematically illustrates an alternative fuse structure 500 to reduce or eliminate time and temperature related changes in an RCS fuse. In the FIG. 5 embodiment, the RCS link 501 is thermally coupled, as by attachment, to a heat sink 502 such as a body of copper. The heat sink 502 lowers the temperature of the RCS link, reducing temperature-related aging. The heat sink can be as simple as a thick polymer film or a strip of Kapton tape upon which an RCS film is deposited.

As an example, a copper block of 9×12.5×13 mm was placed on top of a 0.5×3×4 mm RCS foil suspended in air, such that the block was in electrical and thermal contact only with the RCS. With the block, the foil did not ignite from carrying a current of 70 A for 100 s. Without the block, it ignited in 14 s.

Alternatively, annealing RCS at a temperature higher than that seen in service may reduce its diffusion rate at the service temperature due to the formation of intermediate intermetallic compounds that then act as diffusion barriers.

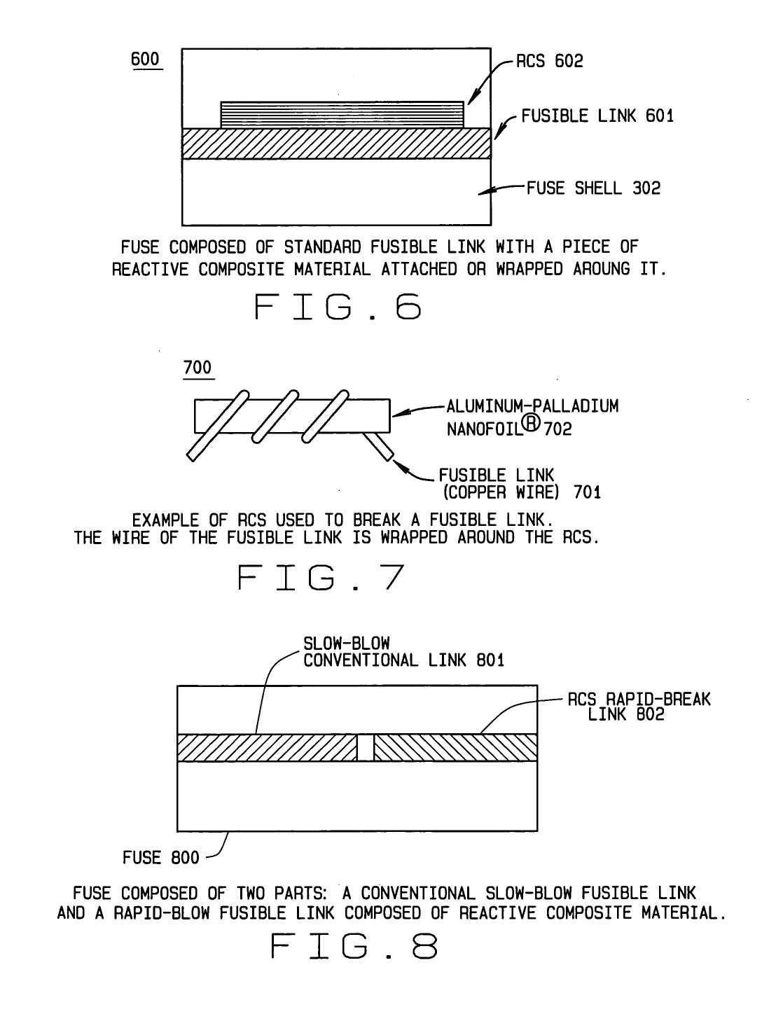

FIG. 6 shows yet another embodiment of a fuse 600 wherein the fusible link 601 is conventional but a piece of RCS material 602 is wrapped or attached to the conventional link 601. In operation, the conventional link 601 carries the current during normal operation of the circuit. In overload, the link 601 overheats and the RCS, in response to the overheating, reacts and heats, melts, and breaks the standard link. The result is a fuse of reduced clearing time and reduced risk of damage to the circuit.

A specific example is sketched in FIG. 7 which illustrates a fuse 700 comprising a copper wire link 701 wound around a strip of cold-rolled aluminum-palladium RCS foil 702 (50 micrometers thick, 250 nm bilayer thickness) of dimension 50 micrometers×1.5 mm×15 mm. When a current of 10 A is passed through the wire link 701, a constant current is observed for about 80 milliseconds. After 80 milliseconds, the current decreases as the wire melts. When compared to the wire without the RCS foil, the current decreases to zero an average of 57 milliseconds faster (243 vs. 300 ms).

FIG. 8 illustrates an alternative embodiment of a fuse 800 wherein the link comprises a conventional link portion 801 in series with an RCS link portion 802. Advantageously, the conventional link portion acts as a slow-acting link that breaks upon long-duration current surges and the RCS link portion acts as a rapid-break link that would react in response to short, high-current pulses.

FIG. 9 illustrates a RCS fuse 900 modified to produce a visual signal while or after the link 901 breaks. The link 901 includes a RCS portion 902 or includes a conventional link portion adjacent to a RCS material. The enclosure 903 is either transparent or is provided with a transparent window 904 so that visual indication of RCS reaction can be observed. A typical characteristic of a RCS is that it emits a flash of light when it reacts. This flash indicates that the fuse has blown. As another visual indication, the RCS can be composed or treated to change color when it reacts. Yet a third visual indication is the tendency of RCS to physically break upon reaction.

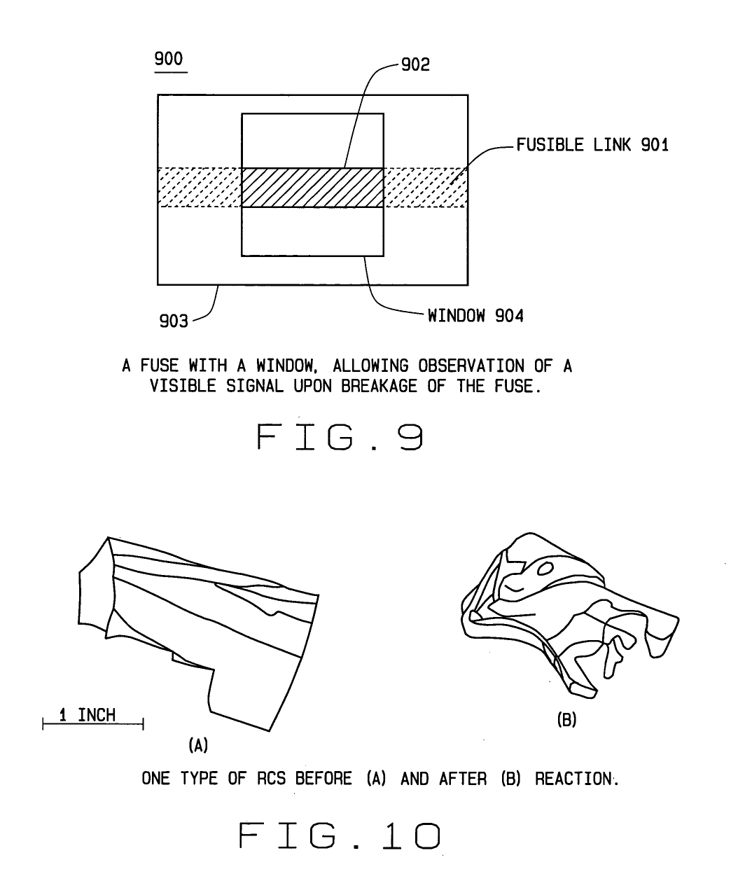

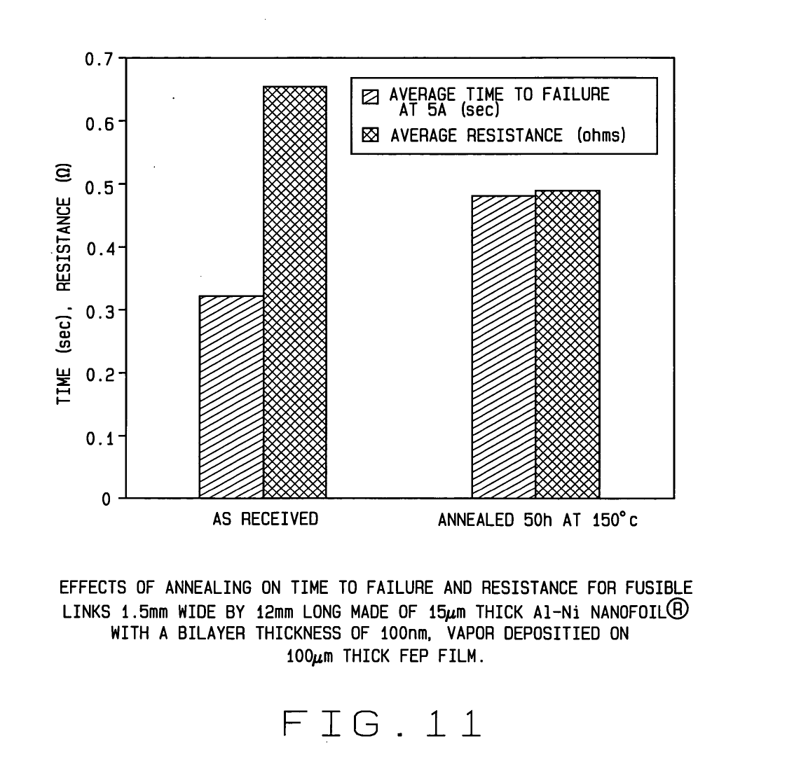

FIG. 10A depicts a vapor deposited aluminum-nickel RCS foil with a layer of copper vapor deposited on both sides. FIG. 10B shows the same foil after reaction. As can be seen, the reaction produces both a dramatic change in color and physical breakage. It should be noted that the thinner the foil, the more breakage is observed.

III. Beneficial Features of Reactive Composite Structures and Methods for Tailoring Them

This part is written for those skilled in the art seeking to tailor the invention to specific applications. There are features and characteristics of reactive composite structures that are advantageous for particular applications. These beneficial features can be tailored to benefit specific fuse applications. The salient beneficial features and characteristics can be roughly categorized as those relating to A. Ignition, stability, storage, environmental compatibility, and safety of the structures; B. Physical properties of the structures; C. Reaction properties; D. Phase and geometry and E. the autonomous nature of the structures. We discuss these features and their tailoring in the order presented.

A. Ignition, Stability, Storage, Environmental Compatibility, and Safety:

1. Controllable Ignition of Reactive Composite Structures
a. Multiple methods can be used to ignite reactive composite structures. For details, see the aforementioned U.S. application Ser. No. 10/959,502. These include but are not limited to electric current, electric spark, thermal pulse, flame, and mechanical impact. All of these methods involve providing a pulse of energy to the reactive composite structure. The large variety of methods provides flexibility when designing reactive composite structures for a given application.
b. The power density and energy density of the energy pulse that is required to ignite reactive composite structures can be controlled as described in Ser. No. 10/959,502. This control provides flexibility when designing these materials for use as or in fuse links. Reactive composite structures can be tailored to be more or less sensitive to ignition and thus break in a given time at lower or higher currents.

2. Stability, Storage Requirements, Environmental Compatibility, and Safety
a. The stability of reactive composite structures and their storage requirements can be controlled by varying design parameters for the structures. This provides flexibility when manufacturing, storing, or designing these structures for use as or in fuse links.
b. An example of a benefit includes the ability to stabilize reactive composite structures to the point where they can be cut, punched, drilled, rolled, drawn and bent without unwanted ignition. This enables the use of many fabrication methods when manufacturing the structures in bulk or in foil form and when shaping them into final geometries for given applications.
c. Another example of a benefit is the ability to design these structures so that they can be stored or held at high temperatures, as high as 150° C. or 200° C. for many days or years without degradation. High temperatures may be caused by the service conditions of fuses, as current passing through a link generates heat. The ability of these structures to withstand this heat over the lifetime of a fuse is thus a benefit.
d. Another example of a benefit is the ability to design these structures so that they are insensitive to ignition by electrostatic discharge or ESD.
e. Another example of a benefit of these reactive composite structures is the ability to design their exteriors to prevent corrosion, oxidation, or discoloration in many wet and dry environments.
f. Another example of a benefit of these reactive composite structures is the ability to choose materials that are more non-toxic or environmentally benign before, during and after reaction than many energetic materials.
g. Yet another benefit of these reactive composite structures is that they can be designed to be safer to manufacture, to handle, to machine, to package and to ship than many energetic materials because they are both more stable and less reactive with environments than many other flammable solids and most explosive materials. Reactive composite structures are classified as 4.1 flammable solids.

3. Designing and Tailoring Ignition, Stability, Storage, Environmental Compatibility, and Safety
a. The requirements for igniting reactive composite structures (energy density and power density) and the stability of reactive composite structures can be raised or lowered by varying design parameters for the reactive composite structures. For example, one can increase ignition requirements and therefore stability and fuse current rating by increasing reactant spacing, layer thickness or particle size, by increasing intermixing between reactants, layers or particles, by adding inert outer or inner layers or phases, and by choosing reactant material systems with high activation energies for their intermixing reactions.
b. Advantageously, an RCS link may be annealed prior to use to tailor its reaction characteristics to a desired level of sensitivity. Annealing the RCS material prior to use may increase the time to failure for a given current. An example of annealing RCS to increase its time to failure can be seen in the plot in FIG. 11. An Al—Ni RCS foil 15 micrometers thick with 100 nanometer bilayer thickness was vapor deposited on 100 micrometer FEP film. The film was tested under two conditions: 1) as received and 2) after 50 hrs. annealing at 150° C. As shown in FIG. 11, the resistance dropped with annealing, but the time to failure with a current of 5 A increased.
c. The same parameters that increase ignition requirements and stability also broaden the storage requirements for reactive composite structures and enhance their safety. For example, one can raise a reactive composite structure's storage requirements (time at a given maximum temperature) and improve the safety in handling that material during manufacturing, packaging, and shipping by increasing reactant spacing, layer thickness or particle size, by increasing intermixing between reactants, layers or particles, by adding inert outer or inner layers or phases, and by choosing reactant material systems with high activation energies for their intermixing reactions.
d. In a similar fashion one can control a reactive composite structure's resistance to electrostatic discharge (ESD) by increasing reactant spacing, layer thickness or particle size, by increasing intermixing between reactants, layers or particles, by adding inert outer or inner layers or phases, and by choosing reactant material systems with high activation energies for their intermixing reactions.
e. One can control the stability of a reactive composite structure's appearance (corrosion, discoloring, etc) by coating that reactive composite structure with a chemically and environmentally stable outer layer. Examples would include but are not limited to aluminum, stainless steel, gold, and certain polymers.
f. One can control the toxicity and environmental compatibility of a reactive composite structure by choosing reactant material systems that are initially non-toxic and/or react to produce non-toxic products.
   B. Physical Properties—Before Reaction, After Reaction, and Change from Before to After Reaction:

The following describes physical properties of reactive composite structures that can be varied through design and manufacturing. The properties can be designed and manufactured to be homogeneous throughout the material or they can be designed and manufactured to vary through the thickness or along the length of the material. In addition, the properties can be designed and manufactured to be isotropic (uniform in all directions) or anisotropic (vary from one direction to another). Lastly, these properties can be designed to achieve an average or effective value within the reactive composite structure before, during, and/or after its reaction, as well as a change in one or more of these properties from before to after its reaction.

1. Thermal Properties
a. Thermal conductivity can be varied from 5 to 400 W/m-K
b. Heat capacity can be varied from 0.1 to 1.0 J/g-K
c. Coefficient of Thermal Expansion (CTE) can be varied from 1 um/m-K to 23 um/m-K
d. Effective melting temperature can be varied from 400K to 3000K

2. Electrical and Magnetic Properties
a. Electrical conductivity can be varied from 10⁸ to 10⁻²⁰ Ω⁻¹m⁻¹
b. Relative maximum magnetic permeability can be varied from 0 to 10⁴

3. Optical and Surface Properties
a. The surface can be varied from reflective to antireflective for visible light
b. Surface topography can be varied from smooth to rough
c. Surface color can be varied across the color spectrum
d. Substrate backings or external coatings can be applied that enhance insulation, absorption, reflection, etc.

4. Mechanical Properties
a. Density can be varied from 1 to 18 g/cc
b. Strength can be varied. For example yield strength can range from 1 MPa to 1000 MPa
c. Elastic stiffness can be varied. For example Young's Modulus can range from 1 GPa to 1000 GPa
d. Fracture toughness can be varied. For example Mode I fracture toughness can range from 1 MPa-m^{0.5} to 100 MPa-m^{0.5}
e. Ductility can be varied. For example tensile ductility can range from 0.1% to 100%
f. Deformability can be varied.
g. Products can be plastically processed (extruded, bent, etc.) into final shape and this ability can be varied.

5. Variation of Physical Properties

The ability to vary the physical properties of reactive composite structures is very advantageous in the application of reactive composite structures. A partial list of benefits that are gained by this ability is given below:
a. Release and transfer of energy generated by the reactive composite structure: The main function of the reactive composite structure is to release and transfer energy that it generates to some environment or neighboring component. That energy is typically in the form of thermal energy or optical energy. The rate at which these energies are released will depend strongly on the thermal properties as well as the emissivities of the materials in the reactive structure. For example, higher values for both will enable faster release and transfer of energy out of the reactive composite structures once they react. Higher releases of energy can speed the rate at which the desired function of the reactive composite structure is accomplished. An example would be the release of thermal energy from a reactive composite structure designed to break a conventional fuse link. or the release of optical energy (light) to provide an optical signal that the fuse had blown. Being able to tailor the rate at which energy is released and transferred from a reactive composite structure is very advantageous.
b. Transfer (absorption, movement and release) of external energies, fields or forces before, during and after reaction: There are many applications of reactive composite structures in which they provide another function, besides releasing energy when they react. They may need to absorb thermal energy, electric energy, magnetic energy, optical energy, or mechanical energy from external sources; they may need to transport thermal energy, electric energy, magnetic energy, optical energy, or mechanical energy from external sources across their geometries; and they may need to release to a neighboring component or the surrounding environment thermal energy, electric energy, magnetic energy, optical energy, or mechanical energy that was absorbed from external sources, either prior to reaction, during reaction, or after reaction.
Almost all reactive composite structures will need to absorb energy from an external source, at least in a small volume, in order to be ignited and thereby react either partially or completely. The more readily that the reactive composite structures absorb heat, electrical current, magnetic fields, light, or mechanical energy, the more easily they can be ignited. The converse is also true. The application of reactive composite structures as sensors is another good example in which they must absorb thermal energy, electric or magnetic fields, optical energy, or mechanical energy. Thus, by tailoring the physical properties of the reactive composite structures, absorption of energy, and hence ignition and sensing, can be designed to be more or less difficult.
In a similar manner, many reactive composite structures will need to transfer energy or fields across their volumes before, during or after their reaction. For example, in the interrupter applications described herein, the reactive composite structure may need to transfer electrical current or magnetic fields prior to reaction but not after reaction. Thus, electrical conductivity or magnetic permeability of the reactive composite structure will need to be sufficient in order to accomplish this transfer. In these examples the ability to tailor the transfer of energies or forces can be very beneficial.
Finally, many external fields, energies or forces that are absorbed from an external source and transferred across reactive composite structures also need to be released to a neighboring environment or component. The two above sets of examples can be used again. For the interrupter application, electrical currents or magnetic fields need to be transferred to a neighboring component, and for debonding and structural energetic applications, forces need to be released or transferred to neighboring components. Being able to tailor physical properties of the reactive composite structures improves the designer's ability to enable effective release rates of externally applied fields, energies or forces.
c. Change of surface properties and color: the exothermic reaction within a reactive composite structure can be designed to change its surface properties and color. Reflectivity, roughness, emissivity, and color can all be changed through the oxidation of the outer surface, through a chemical change of the outer surface, and through a roughening of the outer surface of the reactive composite structure during its reaction. For example, if the outer layer of an Al—Ni reactive composite structure is Al, then its properties will change as it reacts with the neighboring Ni layer towards the interior. The final Al—Ni composition of the outer layer will have different emissivity, reflectivity, and color. The roughness can also be increased through the oscillatory propagation of the exothermic reactions. An outer coating can also be applied to the reactive composite structure that will maximize or minimize these changes upon reaction. The outer coating or the reactive composite structure itself can also be designed to have the degree of its surface color change be dependent on the environment in which the reactive composite structure reacts. For example, a Cu coating will turn from copper orange to green with an oxygen-containing environment (as shown in FIG. 10) but will remain orange in a vacuum.

6. Designing and Tailoring Physical Properties

Typically, the physical properties of reactive composite structures will be a volume average of the reactants. Thus, by varying the volume fraction of any one reactant or by varying which reactants are incorporated, the physical properties of a reactive composite structure can be altered significantly. For example, the combination of 50 atomic % Al and 50 atomic % Ni produces a reactive composite structure with a relatively high thermal conductivity, electrical conductivity, and magnetic permeability, a moderately reflective surface, and a moderate strength and stiffness. By decreasing the percentage of Al and increasing the percentage of Ni, the reactive composite structure's thermal and electrical conductivity will decrease significantly due to the lower conductivity of Ni compared to Al. Its magnetic permeability will increase due to the magnetic nature of Ni and the nonmagnetic nature of Al, and its strength, stiffness, and density will increase due to the stronger, stiffer, and denser nature of Ni compared to Al. The material's reflectivity may also increase if more Ni is exposed at the reactive composite structure's surface.

In another example, if Ti is substituted for Al above, the thermal and electrical conductivity would decrease due to the lower conductivities of Ti compared to Al; the magnetic permeability would be unchanged since both are nonmagnetic; and its strength, stiffness, and density would increase due to the stronger, stiffer, and denser nature of Ti compared to Al.

One can also achieve variations in physical properties of reactive composite structures by varying the composition of one of the reactants. Thermal, electrical, magnetic, and mechanical properties of elements are very sensitive to small inclusions of other elements (alloying elements). For example, the thermal and electrical properties of Al are very sensitive to alloying while its mechanical properties are only moderately sensitive. In addition, the magnetic properties of Ni, Co, and Fe are very sensitive to alloying and can be made nonmagnetic with the addition of moderate percentages of other elements (up to 30%).

The average physical properties of reactive composite structures can be varied for a given reactive composite structure as described above. These same methodologies can also be used to vary the physical properties of reactive composite structures across their thickness or along their length or width. Again, the physical properties are varied by changing the volume fraction of a given set of reactants or by changing the reactants (substituting one for another or simply adding a third or fourth) as one moves across a thickness or along a length.

Given the reactants within a reactive composite structure can have very different physical properties, the average physical properties of a reactive composite structure can be very anisotropic, particularly for layered or locally layered reactive composite structures. For example, in the case of a layered Al/Ni reactive composite structure, thermal and electrical conductivities will be higher along the layers than across the layers because the thermal and electrical conductivities of Al are greater than those of Ni. The anisotropy will be even stronger when the materials have greater differences in properties such as in the case of Al and NiOx. Here, the thermal and electrical conductivities will be dramatically different along the layers as opposed to across the layers because the thermal and electrical conductivities of Al are far greater than those of NiO_{X}.

Lastly, the mechanical properties of reactive composite structures can also be varied by simply changing the thickness or the diameters of the reactant layers or particles. (Note: in this case there is no change in the volume percentage of reactants.) A reactive composite structure's strength will decrease and its fracture toughness will increase when thicker layers or larger particles of reactants are used. Significant variations in strength and toughness can be achieved by varying dimensions of spacings, layers, or particles from 1 nm to 50 μm. The reactive composite structure's stiffness and density, though, will not change significantly.

C. Reaction Properties (Velocity, Temperature, and Heat) and Emissions (Heat, Light, Particles, Vapor, Sound):

The characteristics of a reactive composite structure's exothermic reaction, both its properties and its emissions, are central to its performance as an energetic material. How quickly a reaction propagates, its heating rate, its maximum temperature, its temperature decay, and the total heat it contains are critical properties that define how effectively it will perform for a given application. Similarly, the emissions from a reacting composite structure, such as heat, light, particles, vapor and sound, are also critical to defining how effectively it will perform for a given application. Consider the following examples:

1. Examples:
a. Ignition of other reactions: to ignite a reaction in another component or material, a reactive composite structure must transfer some of its stored energy to that neighboring component or material. The rate and efficiency of that transfer will be determined by the properties of the reactive composite structure's reaction as well as by what it emits. Being able to tailor these properties and emissions can dramatically improve the performance of the reactive composite structure as an igniter.
   i) Reaction velocity—the velocity of the exothermic reaction within the reactive composite structure determines the rate at which the area of the component being ignited is heated.
   ii) Reaction temperature and heating rate—the faster the rise and the higher the rise of the reactive composite structure's temperature, the more effectively it will transfer thermal energy and optical energy to a neighboring component that needs to be ignited.
   iii) Reaction heat—the higher the chemical energy density (J/g) that is stored within the reactive composite structure, the higher its maximum temperature and the larger the total heat it can transfer to a neighboring component. The larger the volume of the reactive composite structure, the larger the total heat available for transfer, although the maximum temperature will not change significantly.
   iv) Light, particles and vapor—the higher the reactive composite structure's emissivity, the more light it will emit for a given reaction temperature and the better its transfer of optical energy to a neighboring component. Being able to emit hot particles and a hot vapor can also dramatically speed the transfer of energy from the reactive composite structure to a neighboring component that needs to be ignited.
b. Energy Source: to supply energy to another component or material, e.g. to melt a conventional fuse link, a reactive composite structure must transfer its stored chemical energy to that neighboring component or material. The rate and efficiency of that transfer will be determined by the properties of the reactive composite structure's reaction as well as by what it emits. Being able to tailor these properties and emissions can dramatically improve the performance of the reactive composite structure as an energy source.
   i) Reaction velocity—the velocity of the exothermic reaction within the reactive composite structure determines the rate at which the area of the component is receiving energy. Many applications require transfer of energy over a large area uniformly so the reaction within the reactive composite structure must spread quickly to enable uniformity.
   ii) Reaction temperature and heating rate—the faster the rise and the higher the rise of the reactive composite structure's temperature, the more effectively it will transfer thermal and optical energy to a neighboring component that needs energy.
   iii) Reaction heat—the higher the chemical energy density (J/g) within the reactive composite structure, the higher its maximum temperature and the larger the total heat it can transfer to a neighboring component. The larger the volume of the reactive composite structure, the larger the total heat available for transfer, but the maximum temperature and thus the transfer rate will not change significantly.
   iv) Light, particles and vapor—the higher the reactive composite structure's emissivity, the more light it will emit for a given reaction temperature and the better its transfer of optical energy to a neighboring component. Being able to emit hot particles and a hot vapor can also dramatically speed the transfer of energy from the reactive composite structure to a neighboring component that needs energy.
c. Interrupter: to act as an interrupter and break the flow of electricity, or some other signal or flow, a reactive composite structure must either break itself apart or cause some other component to break apart. This breaking can occur by multiple processes; two of the more common examples include melting and fracture. To melt either the reactive composite structure itself or a neighboring component that carries the signal, the structure's or component's effective melting temperature must be reached through the release and/or transfer of energy. Similarly, to fracture either the reactive composite structure itself or a neighboring component that carries the signal, the structure's or component's effective fracture toughness must be reached through the generation or transfer of mechanical loads and stresses. These mechanical loads and stresses may be generated by nonuniform heating of one side or one part of the reactive composite structure or a neighboring component. For example, if one side or one end of a strip of reactive composite structure, or a neighboring component, is heated rapidly, its desired thermal expansion will be inhibited by the other side or end that has not yet been heated. This difference will lead to large stresses with the heated side or end being in compression and the unheated side or end being in tension. These stresses alone can cause fracture. Alternatively, the bending moment and bending stresses that the compressive and tensile regions introduce could also cause fracture of the reactive composite structure or the neighboring component. The stresses and loads introduced by nonuniform heating are often referred to as thermal stresses.
Another variant of this loading is to uniformly heat a reactive foil or component that has a difference in its coefficient of thermal expansion (CTE), either across itself or between it and a neighboring component. The difference in thermal expansion will lead to thermal stresses and loads even for the case of uniform heating. The rate and efficiency with which a reactive composite structure can generate and transfer its stored energy to either heat or mechanically load itself or a neighboring component or material will be determined by its reaction properties as well as by what it emits. Being able to tailor these reaction properties and emissions can dramatically improve the performance of the reactive composite structure as an interrupter.
Another cause of fracture in the reactive composite structure is the shrinkage that occurs during the chemical reaction. The products of the reaction are usually higher in density than the reactants. Thus, as the products form, the reactive structure draws together, shrinking where possible, cracking where constrained. This shrinking and cracking process of a reactive composite structure can be used to interrupt a signal either directly by fracturing the reactive composite structure or by fracturing a neighboring component that carries the signal.
   i) Reaction velocity—the velocity of the exothermic reaction within the reactive composite structure determines the rate at which the area of the component is receiving energy and therefore is being heated or loaded mechanically. Many interrupter applications require rapid melting or fracturing, and thus rapid heating or loading, over a large area. Thus, the reaction within the reactive composite structure must spread quickly.
   ii) Reaction temperature and heating rate—the faster the rise and the higher the rise of the reactive composite structure's temperature, the more effectively it will transfer thermal energy or mechanical loads to a neighboring component that needs to melt or fracture.
   iii) Reaction heat—the higher the chemical energy density (J/g) within the reactive composite structure, the higher its maximum temperature and the larger the total heat it can transfer to a neighboring component. The larger the volume of the reactive composite structure, the larger the total heat available for transfer, although the maximum temperature will not change. In addition, the change in density from reactants to products tends to scale with reaction heat. The higher the heat of reaction, the great the density change.
   iv) Light, particles vapor and odor—the higher the reactive composite structure's emissivity, the more light it will emit for a given reaction temperature and the better the transfer of optical energy to a neighboring component that needs to melt or be loaded mechanically by thermal stresses. Being able to emit hot particles and a hot vapor can also dramatically speed the transfer of energy from the reactive composite structure to a neighboring component that needs energy for melting or mechanical loading. In addition, the hot particles and vapor can also apply a pressure directly to the reactive composite structure or a neighboring component that will cause it to fracture. Lastly, emitting a strong odor can prove to be an effective signal or deterrent.

2. Designing and Tailoring Reaction Properties

The reaction properties of reactive composite structures and their emissions can be tailored by varying the volume fraction of reactants, the type of reactants, the spacing of reactants, the volume of reactants, internal structure of the reactive composite structures, and the coatings applied to the surface of the reactive composite structures. Details are provided for each reaction property (velocity, temperature, and heat) and each reaction emission (heat, light, particles, vapor, and sound):
a. Reaction Velocity: the velocity of a self-propagating reaction is determined by the rate at which the chemical reaction occurs within a reactive composite structure and the rate at which the resulting thermal energy is transferred into unreacted regions of the reactive composite structure. The rate at which the chemical reaction occurs is determined mainly by properties such as the heat of reaction, the temperature of reaction, the rate of atomic interdiffusion, the spacing of reactants, and the initial intermixing of reactants. Higher reaction heats, reaction temperatures, and atomic interdiffusion rates and smaller reactant spacings and initial intermixing thicknesses lead to higher reaction velocities. The rate at which thermal energy is transferred to unreacted regions of the reactive composite structures is determined mainly by the reactive composite structure's thermal diffusivity, heat capacity, and density and heat losses to surrounding components or environments. Higher thermal diffusivity and lower heat capacity, density and heat losses all lead to higher reaction velocities.
b. Reaction Temperature: reaction temperature is determined mainly by the given reactants and their volume fraction. Maximum reaction temperatures can be varied from values below 1300K for reactants such as Ti and Al to above 3000K for reactants such as Ti and B. The heating rate in a given location is determined by the rate at which the reactants mix which in turn is determined by their spacing and their interdiffusion rates. Thus, by judiciously choosing the reactants (heats of reaction and interdiffusion rates), their relative volume fractions, and their average spacing, one can tailor the maximum temperature and the rate of heating to this maximum temperature. The decay rate of the temperature will be determined by the volume of the reactive composite structure (size of energy or heat reservoir), the thermal properties of the reactive composite structure, and the contact with and thermal properties of neighboring components. Thus, for example, one can slow the decay rate of the reaction temperature by increasing the volume and lowering the thermal conductivity of the reactive composite structures.
c. Reaction Heat: the heat of reaction within a reactive composite structure is determined by the reactants that are present and their relative volume fraction. For example, the combination of 50 atomic % Al and 50 atomic % Ni produces a heat of reaction near 1400 J/g or 59 kJ/mol. By decreasing the percentage of Al or Ni, this heat can be reduced. Alternatively, by substituting Ti for Ni, the heat of reaction can also be reduced, while by substituting NiOₓ for Ni, the heat of reaction can be increased. Heats of reaction (formation, reduction-oxidation, and reduction-formation) for a wide variety of reactants have been quantified and published.
d. Emission of Heat: the emission of heat from a reactive composite structure is determined not only by the amount of heat that is generated but also by the rate at which heat is generated and the rate at which it can be transferred to a surrounding component or the environment.
e. Emission of Light: the emission of light is determined by the surface temperature and emissivity of the reactive composite structure. As both values increase, the emission of light increases. The control of reaction temperature is mentioned above. A reactive composite structure's emissivity can be increased (or decreased) by coating the reactive composite structure with a material with a high (or low) emissivity. Roughening the surfaces of more reactive composite structures can also alter their emissivity and reflectivity.
f. Emission of particles: a reactive composite structure can be coated with particles that are emitted from its surface on ignition. Alternatively, the reactive composite structure can be designed to break up into hot particles on reaction. The particles could be liquid, solid, or a combination of both. Reactive composite structures that contain high-energy formation reactions or thermite (reduction-oxidation) reactions are likely to emit hot particles, particularly if the spacing between reactants is coarse. In this case, some but not all of the reactants intermix as the reaction initially propagates across the reactive composite structure. The partial reaction of the reactive composite structure can release sufficient energy to break the remaining structure into hot particles that continue to react as they are emitted from the base material. For instance, aluminum-palladium multilayer foils emit molten droplets that solidify into PdAl. Thus, with careful choice of coatings and reactants, one can control the emissions of particles from reactive composite structures.
g. Emission of vapors and odors: many reactive composite structures remain solid during their exothermic reactions, such as low energy Ni—Al foils. However, almost all reactive composite structures can be coated with low melting temperature materials (lead, tin, zinc, solders, etc) that will evaporate as the reactive composite structure reacts and releases energy to the coating. The volume of vapor generated will scale with the thickness of the coating and the energy of the foil. Alternatively, one can design reactive composite structures that have sufficient energy to vaporize all or part of their reactants or reaction product. This is the case with high-energy formation reactions and many thermite or reduction-oxidation reactions. Finally, one can coat reactive composite structures with materials that will generate odors when heated. Thus, through careful choice of coatings and reactants, one can control the emissions of vapors and odors from reactive composite structures.
h. Emission of sound: reactive composite structures can produce sounds through the rapid emission of vapors, particularly emission into a confined volume. Using the guidelines for the generation of vapors noted above one can maximize the emission of sound. Also, one can design outer coatings on the reactive composite structures or internal porous structures within the reactive composite structures that will help to confine the gas so as to generate sound upon reaction.
   D. Phase and Geometry of Reactive Composite Structures:

Reactive composite structures can be designed to be in a solid, liquid, or vapor phase or a combination of these phases during or immediately after reaction. Reactive composite structures can be designed so that their initial and final reacted geometries are in a variety of forms including sheet, strip, wire, hollow tube, block, etc. In addition, reactive composite structures can be designed to alter their initial geometries upon reaction so that the final reacted geometry is different from the initial reacted geometry. One simple example of this is the design of reactive composite structures with inner core layers consisting of materials with low melting temperatures that enable the reactive composite structure to split into multiple pieces on reaction, through the melting and flow of this inner core layer. These different phases and geometries can offer significant advantages in many different applications. A few examples are listed below:

1. Examples
a. Interrupter: to act as an interrupter and break the flow of electricity, or some other signal or flow, a reactive composite structure must either break itself apart or cause some other component to break apart. This breaking can occur by melting or vaporization of the reactive composite structure. The ability to design a reactive composite structure that melts or vaporizes on reaction will enable faster interruption and higher performance of reactive composite structures in fuse-like applications. Melting and vaporization can be enabled by choosing reactants and/or inner core layers that will melt at lower temperatures. Choosing an initial external structure that breaks apart on reaction can also be beneficial to this application. Thin strips or wires and narrowing strips or wires are more likely to break or fracture on reaction than thicker geometries and therefore will be more effective as fuses. Being able to design or tailor the phases of reactive composite structures during reaction and the initial geometries of reactive composite structures can dramatically improve their performance as interrupters.
b. Breaking Apart or Debonding: the melting or vaporization of a reactive composite structure that is initially holding two components together can enable those two components to break apart upon reaction. The reactive composite structure can also be designed in a hollow geometry or with a soft core layer that will enable the reactive composite structure to split apart and thereby enable two components to break apart as well. Both methods provide a very rapid, low cost, and easy means for breaking apart or debonding components.
c. Signal/Sensor: a reactive composite structure that melts, vaporizes or splits apart can be used as a visual signal that some other event has occurred. The appearance of the foil will be dramatically different than prior to reaction. Only a small pulse of energy would be needed to start the reaction in a large sheet of reactive composite structure and by reacting over a large area, a large visible signal is obtained.
d. Energy Source: a reactive composite structure that melts upon reaction can limit the maximum temperature to which a neighboring device is exposed by absorbing some of the energy of reaction into the heat of fusion. In addition, as the molten reacted product solidifies, it will release additional energy, even though the reaction has been completed. This will extend the duration of the energy delivery or the signal, which can be beneficial for many different applications.

2. Designing and Tailoring Phase and Geometry:
a. Phases during and immediately following reaction: the phase of the reactive composite structure as it reacts and immediately after it reacts can be controlled by varying the volume fraction of reactants and by varying the reactants that are used. Choosing ratios or combinations of reactants that produce more heat on reaction (Ti and B versus Ti and Al) and choosing combinations of reactants that produce final products with lower melting and vaporization temperatures (Pd—Al versus Ni—Al) will promote the formation of liquids and vapors as a reactive composite structure reacts. In a related manner, choosing reactants with lower melting temperatures like Al will enable melting of some of the reactants prior to mixing and reacting.
b. Initial and Final Geometries: reactive composite structures can be deposited, rolled, extruded, bent, cut, machined, riveted, bolted or glued into a variety of geometries prior to reaction. These initial geometries can be beneficial to a particular application in the transfer of energies or signals, but they can also be beneficial in that they will enable a change in geometry on reaction such the breaking of a fuse or a bond.
c. Core Layers or Particles: reactive composite structures can be fabricated with inner layers or particles that contain materials with low melting temperatures such as lead, tin, zinc and aluminum. These materials can be deposited, rolled, or bonded into the interior of reactive composite structures. Once the reactive composite structure begins to react, heat from the reaction will melt these layers or particles and will enable the reactive composite structure to break apart in a controlled fashion.
   E. Autonomous Nature of Reactive Composite Structure

Reactive composite structures can be designed to react in a partial or self-propagating mode within many different environments (air, vacuum, water, etc.), and at temperatures below, near or above room temperature, without any additional input from the surrounding environment in the form of gases or energy, other than the energy needed for ignition. Many powder-based reactions require additional energy or gaseous oxygen or nitrogen to proceed or self-propagate. But, reactive composite structures that contain reactants capable of formation reactions, reduction-oxidation reactions, reduction-nitridation reactions, and reduction-formation reactions can be fabricated to react locally near the point of ignition and to self-propagate out from the point of ignition. This is particularly beneficial in many different applications as reactive composite structures can act as self-contained energy sources.

1. Designing and Tailoring Autonomous Nature:
Reactive composite structures can be designed and fabricated to react locally or in a self-propagating mode below, near, or above room temperature through careful design of their chemistry and internal structure. By choosing reactions with sufficiently large heats (>800 J/g) and sufficiently fine spacings of reactants (<10 um) many different formation reactions, reduction-oxidation reactions, reduction-nitridation reactions, and reduction-formation reactions can be made to self-propagate below, near, or above room temperature without additional energy or gases from the surroundings. All that is needed is a pulse of energy with sufficient power and energy density to start the reaction in one location.
As the heats of reaction are decreased and/or the spacing of reactants is increased, the reactive composite structures can be designed to react locally but not to self-propagate across their full geometry. This can be beneficial in some signaling applications where a local reaction offers a signal that an energy pulse has been received in a particular location, for example from a laser.

It can now be seen that one aspect of the invention is an electrical circuit that includes a fuse to protect the circuit from high current. The fuse comprises a reactive composite structure that, upon the flow of the high current in the circuit, undergoes an exothermic chemical reaction that interrupts flow of current in the circuit. In one embodiment the reactive composite structure is electrically conductive. It conducts current in the circuit and, upon the high current, undergoes the chemical reaction that interrupts the flow of current. The reactive composite structure can be annealed or coupled to a heat sink to reduce effects of aging.

In another embodiment the reactive composite structure is thermally coupled to a conductive fuse link. The high current can heat the link and the heat can trigger the reactive composite to react and break the conductive link.

In yet another embodiment, the reactive composite is exposed to view, as through a transparent enclosure or transparent window, and provides a visual signal of reaction and current interruption.

In another aspect, the invention encompasses the fuses that thus protect the circuits. A typical such fuse comprises an enclosure including an internal passage extending between conductive elements at each end. A conductive link electrically connects the two end elements, and a reactive composite structure is positioned so that, upon the flow of high current, the reactive composite undergoes an exothermic chemical reaction that interrupts the flow of current. The reactive composite can be the conductive link, can be in series with a non-reactive conductor to form a composite link, or can be in thermal contact with a non-reactive link so that heating of the non-reactive link triggers a reaction in the reactive composite.

Yet another aspect of the invention is the fabrication of these circuits and fuses by disposing the reactive composite structures in the fuse structure to interrupt current flow or break the link when high current or heat it causes make the composite react.

It is to be understood that the above-described embodiments are illustrative of only a few of the many possible specific embodiments of the invention. Numerous and varied other arrangements can be devised by those skilled in the art without departing from the spirit and scope of the invention.

What is claimed is:

1. An electrical circuit that includes a fuse to protect the circuit from high current, the fuse comprising a reactive composite structure that, upon the flow of high current in the circuit, undergoes an exothermic chemical reaction that interrupts flow of current in the circuit.

2. An electrical circuit according to claim 1 wherein the reactive composite structure is electrically conductive, conducts current in the circuit and, upon the flow of high current undergoes an exothermic chemical reaction that interrupts flow of current through the reactive composite structure.

3. An electrical circuit according to claim 1 wherein the reactive composite structure comprises an annealed reactive composite structure.

4. An electrical circuit according to claim 1 wherein the reactive composite structure is thermally coupled to a heat sink.

5. An electrical circuit according to claim 1 wherein the fuse comprises a conductive fuse link, the reactive composite structure is thermally coupled to a fuse link and, upon the flow of high current in the circuit, the reactive composite structure undergoes an exothermic chemical reaction that breaks the conductive fuse link.

6. The electrical circuit of claim 5 wherein the exothermic chemical reaction is caused by the high current heating the conductive fuse link.

7. The electrical circuit of claim 1 wherein the fuse comprises a conductive fuse link that includes a conductive link of nonreactive material in series with a conductive link of reactive composite material.

8. The electrical circuit of claim 1 wherein the reactive composite structure is exposed to view to provide a visual signal of current interruption.

9. The electrical circuit of claim 8 where the visual signal comprises a flash of light.

10. The electrical circuit of claim 8 where the visual signal comprises a change in the color of the reactive composite structure.

11. The electrical circuit of claim 8 where the visual signal comprises breakage of the reactive composite structure.

12. The electrical circuit of claim 1 wherein the reactive composite structure comprises a composite foil composed of alternating layers of materials that can exothermically react.

13. An electrical fuse for protecting an electrical circuit from high current comprising:
an enclosure including an internal passage extending between two conductive ends;
a reactive composite structure positioned in relation to the link so that upon the flow of the high current, the reactive composite undergoes an exothermic chemical reaction that interrupts the flow of current.

14. The fuse of claim 13 wherein the conductive link comprises the reactive composite structure.

15. The fuse of claim 13 wherein the conductive link comprises the reactive composite structure in series with a non-reactive conductor.

16. The fuse of claim 13 wherein the reactive composite structure is thermally coupled to the conductive link.

17. The fuse of claim 13 wherein the reactive composite structure is exposed to view to provide a visual signal of reaction.

18. The method of making a fuse comprising a conductive link electrically connecting two conductors comprising the step of electrically or thermally coupling the link to a reactive composite structure so that high current or the heat it creates causes the reactive composite to undergo an exothermic chemical reaction that breaks the link.

19. The method of claim 18 wherein the reactive composite structure is serially coupled between the two conductors.

20. The method of claim 18 wherein the reactive composite is thermally coupled to the link.
